(19) United States
(12) Patent Application Publication
(10) Pub. No.: US 2021/0158406 A1
(43) Pub. Date: May 27, 2021

(54) MACHINE LEARNING-BASED PRODUCT AND SERVICE DESIGN GENERATOR

(71) Applicant: INTERNATIONAL BUSINESS MACHINES CORPORATION, Armonk, NY (US)

(72) Inventors: Jeremy R. Fox, Georgetown, TX (US); Shikhar Kwatra, Durham, NC (US); Mauro Marzorati, Lutz, FL (US); Sarbajit K. Rakshit, Kolkata (IN)

(21) Appl. No.: 16/697,869

(22) Filed: Nov. 27, 2019

(51) Int. Cl. G06Q 30/02; G06N 20/00; G06F 16/9535

(52) U.S. Cl. CPC G06Q 30/0282; G06N 20/00; G06Q 30/0204; G06Q 30/0201; G06F 16/9535

(57) ABSTRACT

A method for generating a machine learning-based product and service specification is provided. The method may include extracting online user data associated with one or more online websites and applications. The method may further include identifying user-specific information for each user based on the extracted online user data. The method may also include determining categories of users based on the user-specific information that is shared between users. The method may further include identifying online feedback that is shared between a majority of users and online feedback that is based on the categories of users. The method may also include receiving input for generating the machine learning-based product and service specification. The method may further include generating the machine learning-based product and service specification based on the received input, the one or more categories of users, the first set of online feedback, and the second set of online feedback.

### BACKGROUND

The present invention relates generally to the field of computing, and more specifically, to a computer-implemented, machine learning-based product and service specification generator.

Generally, a product or service may be designed to address one or more needs or requirements for a particular industry, a group of users, or a particular type of user. More particularly, a product or service designer may explore ways in which a product or service may solve a pre-identified user need or problem. As such, product and service design may include various processes that are usually completed by a group of people with different skills and training—e.g. industrial designers, field experts (prospective users), engineers (for engineering design aspects)—and may also depend on the nature and type of product involved. The design process often includes figuring out what is required, brainstorming possible ideas, creating mock prototypes, and then ultimately generating the product. Additionally, designers need to evaluate the success or failure of the product for future modifications and/or new designs.

### SUMMARY

A method for generating a machine learning-based product and service specification is provided. The method may include extracting online user data associated with one or more online websites, applications, and services that a user may access via a computing device. The method may further include identifying user-specific information for each user based on the extracted online user data. The method may also include determining one or more categories of users by determining whether one or more pieces of the user-specific information is shared between one or more users. The method may further include identifying a first set of online feedback that is shared between a majority of users and a second set of online feedback that is based on the one or more categories of users. The method may also include receiving input for generating the machine learning-based product and service specification. The method may further include generating the automated machine learning-based product and service specification based on the received input, the one or more categories of users, the first set of online feedback, and the second set of online feedback.

A computer system for generating a machine learning-based product and service specification is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include extracting online user data associated with one or more online websites, applications, and services that a user may access via a computing device. The method may further include identifying user-specific information for each user based on the extracted online user data. The method may also include determining one or more categories of users by determining whether one or more pieces of the user-specific information is shared between one or more users. The method may further include identifying a first set of online feedback that is shared between a majority of users and a second set of online feedback that is based on the one or more categories of users. The method may also include receiving input for generating the machine learning-based product and service specification. The method may further include generating the machine learning-based product and service specification based on the received input, the one or more categories of users, the first set of online feedback, and the second set of online feedback.

A computer program product for generating a machine learning-based product and service specification is provided. The computer program product may include one or more computer-readable storage devices and program instructions stored on at least one of the one or more tangible storage devices, the program instructions executable by a processor. The computer program product may include program instructions to extract online user data associated with one or more online websites, applications, and services that a user may access via a computing device. The computer program product may further include program instructions to identify user-specific information for each user based on the extracted online user data. The computer program product may also include program instructions to determine one or more categories of users by determining whether one or more pieces of the user-specific information is shared between one or more users. The computer program product may further include program instructions to identify a first set of online feedback that is shared between a majority of users and a second set of online feedback that is based on the one or more categories of users. The computer program product may further include program instructions to receive input for generating the machine learning-based product and service specification. The computer program product may also include program instructions to generate the machine learning-based product and service specification based on the received input, the one or more categories of users, the first set of online feedback, and the second set of online feedback.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an operational flowchart illustrating steps carried out by a program for generating a machine learning-based product and service specification according to one embodiment;

FIG. 3 is a block diagram of the system architecture of the program for generating a machine learning-based product and service specification according to one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

As previously described, embodiments of the present invention relate generally to the field of computing, and more particularly, to providing a computer-implemented, machine learning-based product and service specification. The following described exemplary embodiments provide a system, method and program product for generating a machine learning-based product and service specification. Specifically, the present invention has the capacity to improve the technical fields associated with the design process for a product and/or service by using available online user data and feedback to determine one or more specification requirements for a product and/or service and generating the product/service based on the user data and feedback. Specifically, the present invention may extract and analyze social network and other user data to identify various types of users and categories of users as well as to identify various user-wide topics, feedback, problems, and needs related to different products and services. Furthermore, the present invention may receive as input product/service specification parameters and/or a problem related to designing a product or service, analyze the input based on the identified types of users and the identified user-wide feedback which may include problems with similar products and services, and generate specification requirements for the product and/or service based on the received input, the identified categories of users, and the identified user-wide feedback.

As previously described with respect to product and service design, a product or service may be designed to address one or more needs and problems for different users. Product designers may identify, investigate, and validate the problem, and ultimately craft, design, test and provide a solution. However, getting quality product feedback is essential when building or having just built a new product. This feedback can provide critical data that will ultimately drive product strategy. Specifically, it may be important to collect feedback from various sources consistently to continuously identify such things as problems with a product, market trends, and target users. For example, potential users may come from various backgrounds, demographics, and socio-economic statuses. Therefore, while designing a product, it may be helpful to identify various points of view from the various types of potential users to reinforce a design of a product or service. More specifically, a wide range of sources can give a more complete picture of how a product or feature is received by the customer and/or may provide a foundation for the creation of a new product. Additionally, collecting product feedback consistently may help iterate designs faster. As such, it may be advantageous, among other things, to provide a method, computer system, and computer program product for generating a product and/or service specification based on an automated machine learning-based product and service design system. Specifically, the method, computer system, and computer program product may extract and analyze social network and other user data to identify various types of users and categories of users as well as to identify various user-wide topics, feedback, problems, and needs related to different products and services. The method, computer system, and computer program product may also receive as input parameters for a product/service and/or a problem related to designing a product or service and may analyze the product/service specification parameters and problem based on the identified categories of users and the identified user-wide feedback that may include problems with similar products and services. Thereafter, the method, computer system, and computer program product may generate specification requirements for the product and/or service based on the received input, the identified categories of users, and the identified user-wide feedback, whereby the specification requirements may include one or more designs of the product and/or service.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

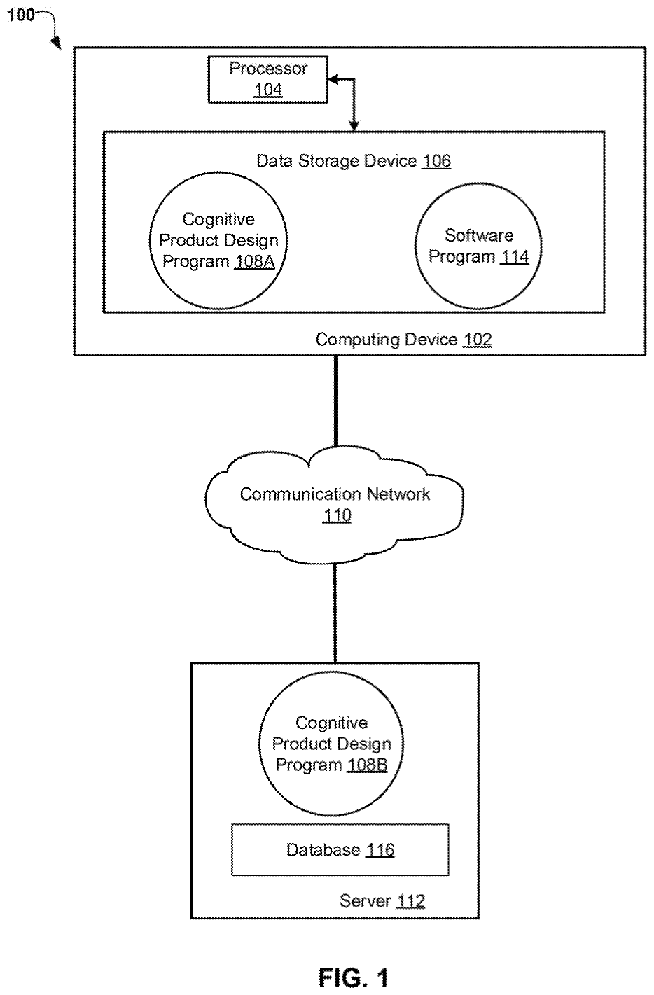

Referring now to FIG. 1, an exemplary networked computer environment 100 in accordance with one embodiment is depicted. The networked computer environment 100 may include a computer 102 with a processor 104 and a data storage device 106 that is enabled to run a cognitive product design program 108A and a software program 114, and may also include a microphone (not shown). The software program 114 may be an application program such as an internet browser and/or one or more mobile apps running on a client computer 102, such as a desktop, laptop, tablet, and mobile phone device. The cognitive product design program 108A may communicate with the software program 114. The networked computer environment 100 may also include a server 112 that is enabled to run a cognitive product design program 108B and the communication network 110. The networked computer environment 100 may include a plurality of computers 102 and servers 112, only one of which is shown for illustrative brevity. For example, the plurality of computers 102 may include a plurality of interconnected devices, such as the mobile phone, tablet, and laptop, associated with one or more users.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

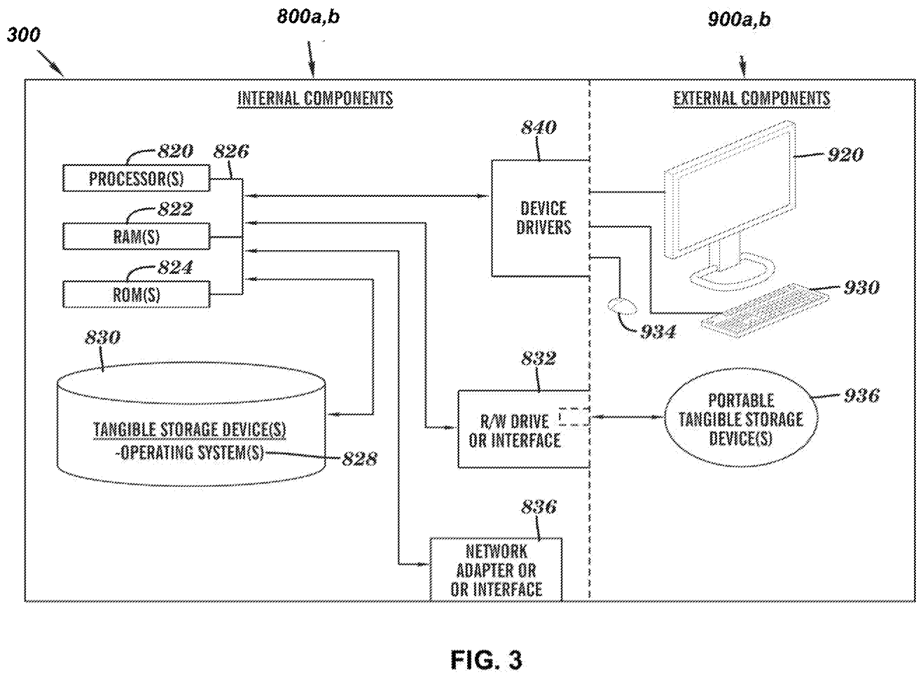

The client computer 102 may communicate with server computer 112 via the communications network 110. The communications network 110 may include connections, such as wire, wireless communication links, or fiber optic cables. As will be discussed with reference to FIG. 3, server computer 112 may include internal components 800a and external components 900a, respectively, and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the cognitive product design program 108A, 108B may interact with a database 116 that may be embedded in various storage devices, such as, but not limited to, a mobile device 102, a networked server 112, or a cloud storage service.

According to the present embodiment, a program, such as a cognitive product design program 108A and 108B may run on the client computer 102 and/or on the server computer 112 via a communications network 110. The cognitive product design program 108A, 108B may provide an automated machine learning-based product and service specification that is presented on client computer 102. Specifically, a user using a client computer 102, such as a laptop device, may run a cognitive product design program 108A, 108B that may interact with a software program 114, such as a web browser, to extract and analyze social network and other user data to identify various types and categories of users as well as to identify various user-wide problems, needs, and feedback related to different topics, products, and services. The cognitive product design program 108A, 108B may also receive as input a specification request and/or a problem related to designing a product or service and may analyze the specification request/problem based on the identified categories of users and the identified user-wide feedback that may include problems with similar products and services. Thereafter, the cognitive product design program 108A, 108B may generate specification requirements for the product and/or service based on the received input, the identified categories of users, and the identified user-wide feedback, whereby the specification requirements may include one or more designs of the product or service.

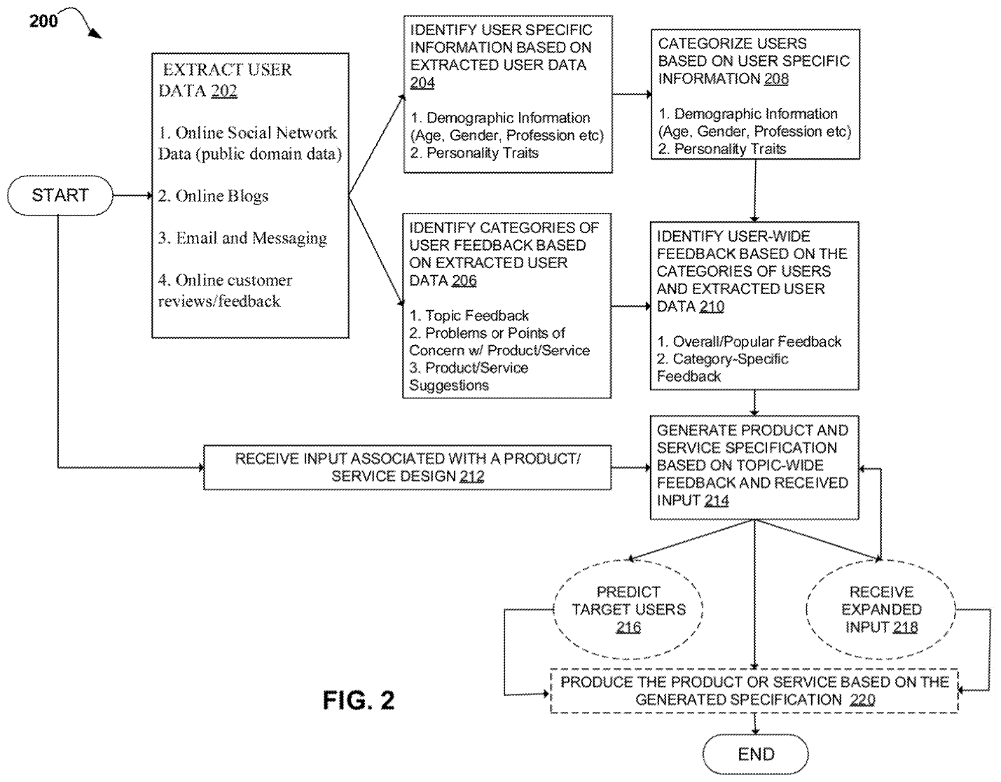

Referring now to FIG. 2, an operational flowchart illustrating the steps carried out by a program for generating a product and/or service specification based on an automated machine learning product and service design system according to one embodiment is depicted. Specifically, at 202, the cognitive product design program 108A, 108B may extract user data. According to one embodiment, the cognitive product design program 108A, 108B may use computer data mining and machine learning techniques (such as classification analysis, clustering analysis, prediction, association rule learning, regression analysis, etc.) to extract the user data onto a database, such as database 116 (FIG. 1). More specifically, the cognitive product design program 108A, 108B may extract user data such as online social networking data, online blog data, email/messaging data, and online user/customer reviews and feedback data associated with a product and/or service that may be detected on one or more websites and applications and/or detected based on different types of metadata associated with a computer and/or computing device. For example, using the data mining and machine learning techniques, the cognitive product design program 108A, 108B may extract online social networking data from social networking websites and apps such as LinkedIn® (LinkedIn and all LinkedIn-based trademarks and logos are trademarks or registered trademarks of LinkedIn Corporation and/or its affiliates), Facebook® (Facebook and all Facebook-based trademarks and logos are trademarks or registered trademarks of Facebook Inc. and/or its affiliates), and Twitter® (Twitter and all Twitter-based trademarks and logos are trademarks or registered trademarks of Twitter and/or its affiliates). Furthermore, the cognitive product design program 108A, 108B may extract user online blog data as well as email/messaging data from online blogging websites and apps and email/messaging websites and apps, respectively, that a user may access via a computer and/or mobile device (i.e. mobile phone, laptop, etc.). Additionally, the cognitive product design program 108A, 108B may extract online user/customer reviews and user feedback data with regard to a product and/or service from websites and apps such as online shopping websites and apps that may, for example, include customer reviews and customer feedback on Amazon® (Amazon and all Amazon-based trademarks and logos are trademarks or registered trademarks of Amazon.com Inc. and/or its affiliates) and customer reviews and feedback on various other websites, blogs, etc.

Next, at 204, the cognitive product design program 108A, 108B may identify user specific information based on the extracted user data. Specifically, based on the extracted user data, the cognitive product design program 108A, 108B may use the data mining and machine learning techniques to identify different types of users and information associated with the different types of users including demographic information and information indicating personality traits associated with the different types of users. For example, the cognitive product design program 108A, 108B may extract information from the social networking websites and apps to identify user demographic information such as age, gender, profession, education level, nationality, location, and marital status. Furthermore, the cognitive product design program 108A, 108B may use psycholinguistic profiling techniques to identify personality traits associated with the different types of users based on, for example, the language used by the users in posts and comments. Specifically, for example, the cognitive product design program 108A, 108B may use psycholinguistic profiling to analyze language such as posts/comments submitted by a user on the social networking websites/apps as well as user feedback and reviews submitted by a user on websites and apps. Based on the analyzed language and the psycholinguistic profiling, the cognitive product design program 108A, 108B may identify personality traits such as identifying whether a user is practical, uncompromising, open-minded, self-conscious, susceptible to stress, cautious, outgoing, active, adventurous, reserved, etc.

Furthermore, at 206, the cognitive product design program 108A, 108B may identify categories of user feedback based on the extracted user data. Specifically, the cognitive product design program 108A, 108B may use the data mining and machine learning techniques to identify different categories of user feedback such as topic feedback that may relate to a product/service feedback, product/service feedback that include posts, comments, and messages that may further include problems and areas of concern a user has with a particular product/service and/or a particular feature of a product/service, and product/service feedback that includes suggestions on how to improve a product/service and/or a particular feature of a product/service.

More specifically, according to one embodiment, the cognitive product design program 108A, 108B may receive feedback related to particular topics. Specifically, the cognitive product design program 108A, 108B may receive feedback relating to problems or areas of concern associated with a particular topic such as, for example, a topic relating to problems that students may encounter when studying, a topic relating to problems workers may encounter when commuting to work in a particular area, and a topic relating to a problem a architect may encounter when designing a building. The cognitive product design program 108A, 108B may use the data mining and machine learning techniques to extract this information from user data such as online social networking data, online blog data, and email/messaging data For example, based on the posts, comments, and messages, the cognitive product design program 108A, 108B may determine that a particular type of user may experience problems waking up in the morning, which may be related to a product such as an alarm clock. Therefore, the cognitive product design program 108A, 108B may identify problems with waking up as a topic among users. Additionally, the cognitive product design program 108A, 108B may determine whether a user's feedback and/or comments includes a direct problem and/or area of concern a user has with a particular product/service and/or a particular feature of a product/service by using natural language processing techniques on the posts, comments, and messages. Furthermore, the cognitive product design program 108A, 108B may detect a user's general likes and dislikes of a product and/or service by detecting whether a user clicks a like button or a dislike button associated with a particular product/service on an interface feature of a website and/or app. Similarly, the cognitive product design program 108A, 108B may use natural language processing techniques to determine whether a user's product/service feedback includes one or more suggestions on how to improve a product/service and/or a particular feature of a product/service.

Next, at 208, the cognitive product design program 108A, 108B may categorize the different users based on the identified user specific information. Specifically, the cognitive product design program 108A, 108B may use the data mining and machine learning techniques to determine similarities between users based on the demographic information extracted from the different users. Thereafter, the cognitive product design program 108A, 108B may categorize the different users based on the determined similarities between the users. For example, the cognitive product design program 108A, 108B may determine the ages of a group of users and categorize the users according to an age group, such as generating a category of users who are between the ages of 20 and 30 years old. The cognitive product design program 108A, 108B may also determine a category of users based on the identified professions of users, such as generating a category of users that include lawyers, generating a category of users that include entrepreneurs, and generating a category of users that are students.

Also, for example, the cognitive product design program 108A, 108B may use psycholinguistic profiling to generate categories of users based on the identified personality traits of users. As previously described at 204, the cognitive product design program 108A, 108B may use the psycholinguistic profiling techniques to identify personality traits associated with different users. As such, the cognitive product design program 108A, 108B may determine a category of users based on the personality traits, such as generating a category of users who are identified as practical, generating a category of users who identified are active, and generating a category of users who are identified as adventurous. Furthermore, the cognitive product design program 108A, 108B may use the data mining and machine learning techniques as well as the psycholinguistic profiling techniques to generate categories based on a combination of demographic information and psycholinguistic profiling. For example, the cognitive product design program 108A, 108B may generate a category of users who are lawyers and are between the ages of 30 and 40, generate a category of users who are entrepreneurs and are adventurous, and generate a category of users who are practical, are over the age of 30, and are susceptible to stress.

Next, at 210, the cognitive product design program 108A, 108B may identify user-wide feedback based on the identified categories of users and the extracted user data. Specifically, the cognitive product design program 108A, 108B may use the data mining and machine learning techniques as well natural language processing techniques to parse, analyze, and compare user feedback and user reviews. Thereafter, based on the user feedback and reviews, the cognitive product design program 108A, 108B may determine an overall or most popular feedback or sentiment that may be associated with a majority of users and may regard, for example, a particular product/service and/or a particular feature of a product/service. For example, the cognitive product design program 108A, 108B may extract and analyze user feedback data associated with a product/service such as an online web service that includes a user interface. Based on the extracted and analyzed user feedback and reviews, the cognitive product design program 108A, 108B may determine that the overall feedback is that users dislike the online web service. Specifically, for example, the cognitive product design program 108A, 108B may determine that a majority of users clicked a dislike button or gave the web service a less than average review by clicking on less than 3 out of 5 stars on a product review. More specifically, for example, the cognitive product design program 108A, 108B may analyze the comments in the user feedback that may be located on websites and/or in emails using natural language processing techniques and determine that a majority of users specifically disliked the user interface and the lack of features on the user interface.

Furthermore, the cognitive product design program 108A, 108B may determine category-specific feedback by identifying user feedback that is specific to and most popular amongst a particular group of users that are identified and categorized at step 208. For example, the cognitive product design program 108A, 108B may determine category-specific feedback associated with the online web service by determining that a category of male users between the ages of 26 and 36 years old suggests that a chat interface be enabled on the online web service. According to one embodiment, the cognitive product design program 108A, 108B may also rank the most popular feedback for each of a product/service, a particular feature of a product/service, and a particular category of users.

Then, at 212, the cognitive product design program 108A, 108B may receive input associated with a design of a product and/or service. Specifically, according to one embodiment, the cognitive product design program 108A, 108B may receive input via a user interface that is associated with the cognitive product design program 108A, 108B, whereby the input may include instructions to design a specification for a new product and/or service that may be based on a problem associated with different users, based on one or more parameters, and/or based on a specification submitted by the user via the use interface. Specifically, according to one embodiment, the cognitive product design program 108A, 108B may receive user input that includes a problem that the user may want to address in the design of a product and/or service. For example, the cognitive product design program 108A, 108B may receive user input via a text box on the user interface whereby the user input includes a problem statement, which may include text and/or a natural language statement, and whereby the user wants to design a smart clock widget that includes an alarm feature to accommodate the alarm needs of various potential users in a household (i.e. children, student, parent) during various times and events of a day.

Also, according to one embodiment, based on the identified user-wide feedback, the cognitive product design program 108A, 108B may identify a problem and provide the problem as input to be resolved when generating the specification. For example, the cognitive product design program 108A, 108B may generally receive user input to generate a specification for a particular type of product and/or service. Thereafter, based on user-wide topic feedback, the cognitive product design program 108A, 108B may recognize and determine that the particular type of product and/or service is popular among students. As such, the cognitive product design program 108A, 108B may also include as input the problems that students face with regard to the particular type of product/service and/or with regard to similar products/services.

Also, according to one embodiment, the cognitive product design program 108A, 108B may receive user input that includes certain parameters whereby the user wants to design a product based on the parameters that may be associated with the extracted user data. For example, the cognitive product design program 108A, 108B may receive user input indicating that the user wants to design a particular product for a certain age group. As such, according to one embodiment, the cognitive product design program 108A, 108B may present one or more menus and/or text boxes that allows a user to input certain restrictions on the design of a product/service. For example, to restrict the generated specification or design of the product to a particular age group, the cognitive product design program 108A, 108B may include in the user interface one or more drop-down menus and/or text boxes whereby the user may select or input the age range of the certain age group (i.e. between 20 and 30 years old, 30 years old or more, 13 years old or less, etc.). Similarly, the cognitive product design program 108A, 108B may also allow the user to restrict the design of the product based on other demographic information and psycholinguistic profiling information, or a combination thereof, as previously described at steps 204 and 208.

Also, according to one embodiment, the cognitive product design program 108A, 108B may receive user input that includes instructions to generate a specification of a product/service based on a specification submitted by the user via the user interface. For example, the cognitive product design program 108A, 108B may allow a user to submit via the user interface a specification document (such as a .pdf, .doc, .docx document) as well as allow a user to select certain restrictions for generating a new specification (i.e. based on demographic information and psycholinguistic profiling information). Thereafter, and as will be discussed with reference to step 214, the cognitive product design program 108A, 108B may analyze the submitted specification based on the inputted restrictions and generate a specification that may include a list of functional requirements based on the identified user-wide feedback associated with the certain restrictions.

Next, at 214, the cognitive product design program 108A, 108B may generate a product and/or service specification based on the received user input and the user-wide feedback. As previously described at step 212, the cognitive product design program 108A, 108B may receive input that may include instructions to generate a product/service specification. Furthermore, the cognitive product design program 108A, 108B may receive input that may include instructions to generate a product/service specification based on one of a problem statement, certain parameters in accordance with demographic and psycholinguistic profiling information, and/or a submitted specification. Thereafter, based on the received input as well as the user-wide feedback identified and analyzed at step 210, the cognitive product design program 108A, 108B may generate a specification of the product/service that may include one or more functional requirements that are necessary to satisfy the received user input and the identified user-wide feedback.

Also, according to one embodiment, in generating the specification, the cognitive product design program 108A, 108B may rank the functional requirements based on the user-wide feedback and present the ranked list of functional requirements in the generated specification. For example, the cognitive product design program 108A, 108B may receive input via the user interface to generate a specification design for a particular type of online web service. In turn, based on the identified user-wide feedback, the cognitive product design program 108A, 108B may determine that the most popular feedback among users regarding that particular type of online web service, and/or similar web services, is that users require a chat interface with the online web service to allow users to chat with other users on the online web service. The cognitive product design program 108A, 108B may also determine that enabling group messaging in the chat interface is the second most popular feedback. Also, for example, and based on the identified user-wide feedback, the cognitive product design program 108A, 108B may determine that including emojis in the chat interface is popular amongst persons 20-30 years old and the second most popular feedback for that age group (i.e. second only to the inclusion of the chat interface itself).

As such, the cognitive product design program 108A, 108B may generate a specification that includes a list of functional requirements where, for example, the functional requirement of a chat interface is listed and ranked first on the list based on the identified user-wide feedback. The cognitive product design program 108A, 108B may also list, and rank as second on the generated specification, group messaging in the chat interface based on the user-wide feedback indicating that enabling group messaging in the chat interface is the second most popular feedback. Similarly, the cognitive product design program 108A, 108B may list and rank the functional requirement of emojis in the chat interface. However, according to one embodiment, the cognitive product design program 108A, 108B may also generate a specification for persons that are 20-30 years old where the functional requirement of emojis may be listed and ranked second only behind the functional requirement of a chat interface since including emojis is the second most popular feedback among persons 20-30 years old. According to one embodiment, the list of functional requirements may be presented as a natural language list of functions to include in the product or the service. For example, the list of functional requirements may be a natural language list that includes a statement such as “a chat interface with group messaging and emojis.” Furthermore, the list of functional requirements may be presented in high-level technical language that, for example, describes a physical product using technical dimensions and features, or a mapping of parts in the product using the technical dimensions and features. Also, as in the case of the previously cited example, the list of functional requirements may be presented using high-level program code for specifications that are based on services such as websites, web services, and web application. For example, according to one embodiment, the generated specification may be include the actual program code to implement the web site, web service, and/or web application.

Furthermore, and as previously described at step 212, the cognitive product design program 108A, 108B may generate a product and/or service specification based on one or more inputted parameters. Specifically, according to one embodiment, the cognitive product design program 108A, 108B may receive user input that includes a problem that the user may want to address in the design of a product and/or service. For example, the cognitive product design program 108A, 108B may receive user input via a text box on the user interface whereby the user input includes a problem statement, which may include text and/or a natural language statement, whereby the user wants to design a smart clock widget that includes an alarm feature to accommodate the alarm needs of various potential users in a household (i.e. children, student, parent) during various times and events of a day. In turn, the cognitive product design program 108A, 108B may generate a product and/or service specification for a smart clock widget based on user-wide feedback regarding smart clocks, and more specifically, based on user-wide feedback regarding smart clocks with respect to the overall shared concerns and needs of a household that includes students, parents, and children who may have expressed feedback online. Also, according to one embodiment, when generating the specification, the cognitive product design program 108A, 108B may prioritize the functional requirements for one type of user over another type of user based on the likelihood of a user using the particular product and/or service which may be determined from the user-wide feedback.

Also, for example, and as previously described, the cognitive product design program 108A, 108B may receive user input indicating that the user wants to design a particular product for a certain age group. As such, according to one embodiment, the cognitive product design program 108A, 108B may present one or more menus and/or text boxes that allows a user to input certain restrictions on the design of a product/service. For example, in order to restrict the generated specification or design of the product to a particular age group, the cognitive product design program 108A, 108B may include in the user interface one or more drop-down menus and/or text boxes whereby the user may select or input the age range of the certain age group (i.e. between 20 and 30 years old, 30 years old or more, 13 years old or less, etc.). Therefore, the cognitive product design program 108A, 108B may generate a product and/or service specification based on the inputted age range by the user. Similarly, the cognitive product design program 108A, 108B may also allow the user to restrict the design of the product based on other demographic information and psycholinguistic profiling information, or a combination thereof, as previously described at step 204.

Thereafter, at 216 and according to one embodiment, the cognitive product design program 108A, 108B may predict target users of the generated product and/or service specification based on the user-wide feedback. Specifically, and as previously described at 210, the cognitive product design program 108A, 108B may identify user-wide feedback based on the identified categories of users and the extracted user data. More specifically, based on the extracted user feedback and user reviews, the cognitive product design program 108A, 108B may determine an overall or most popular feedback or sentiment that may be shared among a majority of users as well as determine category-specific feedback by identifying user feedback that is specific to and most popular among a particular group of users. As such, when generating a specification for a product/service, the cognitive product design program 108A, 108B may determine the target users of the product/service based on the identified user-wide feedback as well as the different categories of users. For example, based on the category-specific feedback, the cognitive product design program 108A, 108B may determine that the particular type of product and/or service may be popular for a group that includes undergrad students who are 20-25 years old. As such, the cognitive product design program 108A, 108B may identify the group as target users of the product/service and thereby list the group as target users in the generated specification and/or generate and present a separate list that includes the one or more groups of target users.

Furthermore, at 218 and according to one embodiment, the cognitive product design program 108A, 108B may receive expanded input for the generated specification. Specifically, and as previously described at 212, the cognitive product design program 108A, 108B may receive input associated with a design of a product and/or service, whereby the input may include instructions to design a specification for a new product and/or service that may be based on a problem associated with different users, based on one or more parameters, and/or based on a specification submitted by the user via the user interface. Similarly, subsequent to generating a specification for a product/service at 214, the cognitive product design program 108A, 108B may receive additional input to, for example, refine the generated specification based on additional input. More specifically, for example, the cognitive product design program 108A, 108B may receive additional input that may include a new problem statement associated with different users and/or one or more additional parameters that may restrict the specification for a particular group. Thus, according to one embodiment, the cognitive product design program 108A, 108B may use the additional input as well as the generated specification to generate a new specification at 214.

Thereafter, at 220, the cognitive product design program 108A, 108B may produce the product or service based on the specification. Specifically, according to one embodiment, the cognitive product design program 108A, 108B may produce the product or service for those generated specifications that are based on a website, a web service, and/or a web application. For example, and as previously described, the cognitive product design program 108A, 108B may determine that some of the most popular feedback among users for a particular type of online website is that users require a chat interface with group messaging and emojis in the chat interface. As such, the cognitive product design program 108A, 108B may generate a specification for the website, for example, by generating a natural language list of requirements and/or by generating the high-level program code for implementing the website. Thereafter, the cognitive product design program 108A, 108B may produce/implement the actual website based on the generated specification, for example, by implementing the website based on the generated high-level program code.

It may be appreciated that FIGS. 1-2 provide only illustrations of one implementation and does not imply any limitations with regard to how different embodiments may be implemented. Many modifications to the depicted environments may be made based on design and implementation requirements.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

FIG. 3 is a block diagram 300 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 800 a, b and external components 900 a, b illustrated in FIG. 3. Each of the sets of internal components 800 a, b includes one or more processors 820, one or more computer-readable RAMs 822, and one or more computer-readable ROMs 824 on one or more buses 826, and one or more operating systems 828 and one or more computer-readable tangible storage devices 830. The one or more operating systems 828, the software program 114 (FIG. 1) and the Cognitive product design program 108A (FIG. 1) in client computer 102 (FIG. 1), and the Cognitive product design program 108B (FIG. 1) in network server computer 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as a Cognitive product design program 108A and 108B (FIG. 1), can be stored on one or more of the respective portable computer-readable tangible storage devices 936, read via the respective R/W drive or interface 832, and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The Cognitive product design program 108A (FIG. 1) and software program 114 (FIG. 1) in client computer 102 (FIG. 1), and the Cognitive product design program 108B (FIG. 1) in network server 112 (FIG. 1) can be downloaded to client computer 102 (FIG. 1) from an external computer via a network (for example, the Internet, a local area network or other, wide area network) and respective network adapters or interfaces 836. From the network adapters or interfaces 836, the Cognitive product design program 108A (FIG. 1) and software program 114 (FIG. 1) in client computer 102 (FIG. 1) and the Cognitive product design program 108B (FIG. 1) in network server computer 112 (FIG. 1) are loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930, and computer mouse 934. The device drivers 840, R/W drive or interface 832, and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

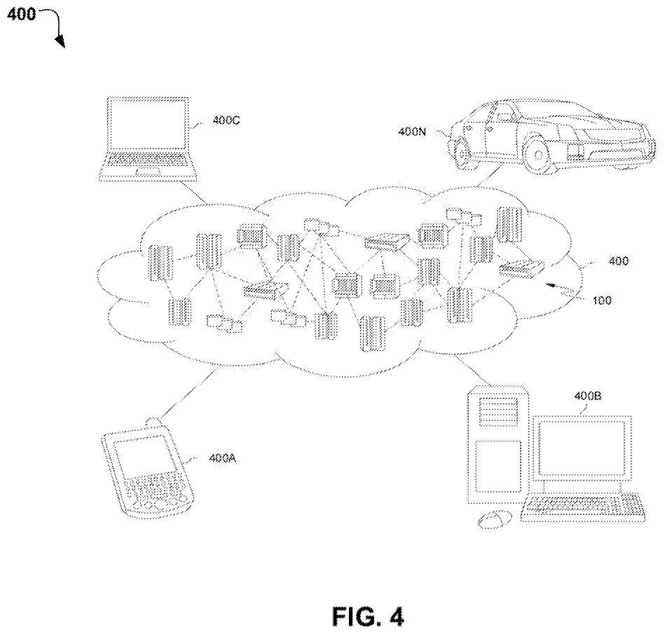

Referring now to FIG. 4, illustrative cloud computing environment 400 is depicted. As shown, cloud computing environment 400 comprises one or more cloud computing nodes 100 with which local computing devices used by cloud consumers, such as, for example, personal digital assistant (PDA) or cellular telephone 400A, desktop computer 400B, laptop computer 400C, and/or automobile computer system 400N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 400A-N shown in FIG. 4 are intended to be illustrative only and that computing nodes 100 and cloud computing environment 400 can communicate with any type of computerized device over any type of network and/or network addressable connection (e.g., using a web browser).

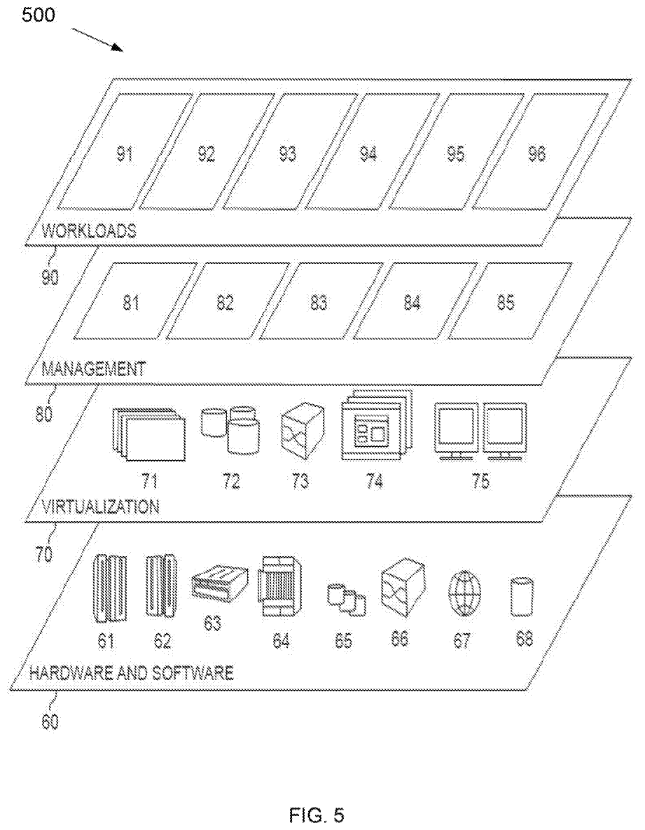

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Cognitive product design 96. A cognitive product design program 108A, 108B (FIG. 1) may be offered “as a service in the cloud” (i.e., Software as a Service (SaaS)) for applications running on mobile devices 102 (FIG. 1) and may generate a machine learning-based product and service specification for a product and service.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating a machine learning-based product and service specification, the method comprising:
extracting, by a computer, online user data associated with one or more online websites, applications, and services that are accessible by a user via the computer;
identifying, by the computer, user-specific information for each user based on the extracted online user data;
determining, by the computer, one or more categories of users by determining whether one or more pieces of the user-specific information is shared between one or more users;
identifying, by the computer, a first set of online feedback that is shared between a majority of users and a second set of online feedback that is based on the one or more categories of users;
receiving, by the computer, input for generating the machine learning-based product and service specification; and
generating, by the computer, the machine learning-based product and service specification based on the received input, the one or more categories of users, the first set of online feedback, and the second set of online feedback.

2. The computer-implemented method of claim 1, wherein the extracted online user data and the user-specific information is selected from a group comprising at least one of demographic information and personality trait information.

3. The computer-implemented method of claim 1, wherein the one or more online websites, applications, and services is selected from a group comprising at least one of social media websites and applications, email websites and applications, messaging websites and applications, and shopping websites and applications.

4. The computer-implemented method of claim 1, wherein the first set of online feedback and the second set of online feedback comprises user-wide feedback that includes one or more topics, product feedback associated with one or more products, and service feedback associated with one or more services.

5. The computer-implemented method of claim 1, wherein the received input for generating the machine learning-based product and service specification is selected from a group comprising at least one of a problem statement, one or more parameters based on demographic information and personality trait information, and a submitted specification.

6. The computer-implemented method of claim 1, further comprising:
in response to generating the machine learning-based product and service specification, predicting, by the computer, target users of the product and service.

7. The computer-implemented method of claim 1, further comprising:
receiving, by the computer, a second set of input for refining the generated machine learning-based product and service specification.

8. A computer system for generating a machine learning-based product and service specification for a product and service, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
extracting online user data associated with one or more online websites, applications, and services that are accessible by a user via a computing device;
identifying user-specific information for each user based on the extracted online user data;
determining one or more categories of users by determining whether one or more pieces of the user-specific information is shared between one or more users;
identifying a first set of online feedback that is shared between a majority of users and a second set of online feedback that is based on the one or more categories of users;
receiving input for generating the machine learning-based product and service specification; and
generating the machine learning-based product and service specification based on the received input, the one or more categories of users, the first set of online feedback, and the second set of online feedback.

9. The computer system of claim 8, wherein the extracted online user data and the user-specific information is selected from a group comprising at least one of demographic information and personality trait information.

10. The computer system of claim 8, wherein the one or more online websites, applications, and services is selected from a group comprising at least one of social media websites and applications, email websites and applications, messaging websites and applications, and shopping websites and applications.

11. The computer system of claim 8, wherein the first set of online feedback and the second set of online feedback comprises user-wide feedback that includes one or more topics, product feedback associated with one or more products, and service feedback associated with one or more services.

12. The computer system of claim 8, wherein the received input for generating the machine learning-based product and service specification is selected from a group comprising at least one of a problem statement, one or more parameters based on demographic information and personality trait information, and a submitted specification.

13. The computer system of claim 8, further comprising:
in response to generating the machine learning-based product and service specification, predicting target users of the product and service.

14. The computer system of claim 8, further comprising:
receiving a second set of input for refining the generated machine learning-based product and service specification.

15. A computer program product for generating a machine learning-based product and service specification for a product and service, comprising:
one or more tangible computer-readable storage devices and program instructions stored on at least one of the one or more tangible computer-readable storage devices, the program instructions executable by a processor, the program instructions comprising:
program instructions to extract online user data associated with one or more online websites, applications, and services that are accessible by a user via a computing device;
program instructions to identify user-specific information for each user based on the extracted online user data;
program instructions to determine one or more categories of users by determining whether one or more pieces of the user-specific information is shared between one or more users;
program instructions to identify a first set of online feedback that is shared between a majority of users and a second set of online feedback that is based on the one or more categories of users;
program instructions to receive input for generating the machine learning-based product and service specification; and
program instructions to generate the machine learning-based product and service specification based on the received input, the one or more categories of users, the first set of online feedback, and the second set of online feedback.

16. The computer program product of claim 15, wherein the extracted online user data and the user-specific information is selected from a group comprising at least one of demographic information and personality trait information.

17. The computer program product of claim 15, wherein the first set of online feedback and the second set of online feedback comprises user-wide feedback that includes one or more topics, product feedback associated with one or more products, and service feedback associated with one or more services.

18. The computer program product of claim 15, wherein the received input for generating the machine learning-based product and service specification is selected from a group comprising at least one of a problem statement, one or more parameters based on demographic information and personality trait information, and a submitted specification.

19. The computer program product of claim 15, further comprising:
program instructions to, in response to generating the machine learning-based product and service specification, predict target users of the product and service.

20. The computer program product of claim 15, further comprising:
program instructions to receive a second set of input for refining the generated machine learning-based product and service specification.
